(19) United States
(12) Patent Application Publication
(10) Pub. No.: US 2008/0208686 A1
(43) Pub. Date: Aug. 28, 2008

(54) Method and system for computer-implemented marketing by a small number of advertisers doing business in a single market

(75) Inventor: William Bartlett Jackson, San Mateo, CA (US)

Correspondence Address: Attn: Alfred A. Equitz;GIRARD & EQUITZ LLP, Suite 1110, 400 Montgomery Street, San Francisco, CA, 94104, US

(73) Assignee: EXCLUSIVEQUEST, INC.

(21) Appl. No.: 11/711,200

(22) Filed: Feb. 27, 2007

(51) Int. Cl. G06Q 30/00

(52) U.S. Cl. 705/14

(57) ABSTRACT

In a class of embodiments, a method of computer-implemented marketing including the steps of providing a web page that includes distinct advertising space for each of N advertisers doing business in a single market but not for any other advertiser, where 1≦N≦8 and the advertising space for each of the N advertisers includes advertising content for said each of the N advertisers, and sending the web page over a computer network. In preferred embodiments, N is equal to six and the advertisers are realtors. Typically, the advertising space is provided in return for consideration from each of the advertisers. Other aspects are processors programmed to perform one or more individual steps of any embodiment of the method and systems including at least one such programmed processor.

### FIELD OF THE INVENTION

The invention relates to methods and systems for computer-implemented marketing of real estate, goods, and services over the Internet and other networks.

### BACKGROUND OF THE INVENTION

In this disclosure below, the expression “goods” (as in marketing of goods) denotes real estate as well as any type of personal property. In this disclosure, the terms “marketing” and “advertising” are used as synonyms.

Various methods are in use for computer-implemented advertising of services and real estate and other goods over the Internet and other networks. Such activity is becoming increasingly significant economically. According to a recently published report, the amount paid in connection with Internet searches for local businesses will reach $4 billion by the year 2010. If this report proves accurate, there will be a rapid increase in online local search advertising with the amount paid in connection with such advertising increasing by approximately one billion dollars per year. As the demand (and price) increases for keyword related searches, advertisers will be looking for opportunities for obtaining greater value for their search marketing dollars. Typical embodiments of the present invention provide advertisers such an opportunity, and can provide them a platform which cuts across multiple search engines to provide the advertisers exposure to a wider audience of potential customers.

It is conventional for search companies to promote websites of individual business entities, but often the information set forth on their websites is not the most important message business entities try to get across to consumers. Rather, business entities typically wish to market specific goods and/or services to customers. Many business entities have simple websites (sometimes referred to as cookie cutter websites) that are nothing more than templates that have been purchased and filled in with limited business-specific information, but are not designed to promote specific goods and/or services. In contrast, typical embodiments of the invention provide business entities (e.g., advertising professionals) an opportunity to promote specific products and/or services; not (or not merely) their websites. Typical embodiments provide even the smallest of business entities that use search marketing an opportunity to use a dynamic, technology rich platform to promote their product(s) and/or service(s), often at a lower price than they could accomplish on their own and without expending significant time and effort for managing the marketing effort. These typical embodiments provide a dynamic advertising platform in the sense that they provide the ability to change advertisements as frequently as needed without the need for an advertiser to redesign a website.

Traditional search marketing campaigns usually involve a single search engine (e.g., Google, Yahoo, Ask, or MSN). The marketer selects targeted keywords and drives traffic to the marketer's website via the search engine. In contrast, in typical embodiments of the invention, targeted keywords are used to drive potential customers who use any of multiple search engines to the inventive web page; not to individual advertiser's sites. In typical embodiments, the inventive web page does have links to individual advertiser's websites.

### SUMMARY OF THE INVENTION

In a class of embodiments, the invention is a method for marketing real estate, including the steps of:

providing a web page that includes distinct advertising space for each of N realtors doing business in a single real estate market (“community”), but not for any other realtor, where 1≦N≦8 and the advertising space for each of the N realtors includes advertising content for said each of the N realtors; and

sending the web page over a computer network (e.g., so that a user's computer system that downloads the web page can display the advertising content for viewing by the user).

In a class of preferred embodiments, N=6. Typically, the advertising space is provided for each of the realtors in return for consideration from said each of the realtors. The consideration can be a monthly fee or other periodic fee, and/or may be determined by a bidding process (e.g., an auction). Each realtor can be either an individual real estate agent or a realty business enterprise. Typically, the computer network is the internet.

In some embodiments, the real estate market is a single city or metropolitan area, or portion of a city or metropolitan area. In other embodiments, the real estate market incorporates more than one city or metropolitan area (e.g., it could be the “Lake Tahoe” area which includes numerous cities in California and Nevada)

In another class of embodiments, the invention is a method for marketing real estate including the steps of:

providing a set of web pages, each of the web pages including distinct advertising space for each of N realtors doing business in a different one of a set of real estate markets (“communities”) but not for any other realtor, where 1≦N≦8 and the advertising space in each of the web pages for each of the N realtors includes advertising content for said each of the N realtors; and

sending at least one of the web pages over a computer network (e.g., so that a user's computer system that downloads the web page can display the advertising content for viewing by the user). In a class of preferred embodiments, N=6. Typically, the advertising space is provided for each of the realtors in return for consideration from said each of the realtors. The consideration can be a monthly fee or other periodic fee and/or may be determined by a bidding process (e.g., an auction). Each realtor can be either an individual real estate agent or a realty business enterprise. Typically, the computer network is the internet.

The term “user” will be used herein interchangeably with “potential customer” and “customer” to describe a person who views, seeks to view, or is a target viewer of a web page generated in accordance with any embodiment of the invention.

In preferred embodiments, a service provider generates (and typically maintains and updates) each of the inventive web pages (incorporating therein advertising content provided by realtors who have paid consideration for advertising space) and operates a host system that include at least one programmed processor. The host system stores each web page and implements an interface that is accessible by potential customers via the internet (or another network) so that the potential customers can access each stored web page. Typically, the interface is or includes a web front end configured to allow potential customers to access the host system via the internet. In preferred embodiments, the service provider manages (e.g., boosts) search engine hits so that when a user searches for “real estate in community X” or the like using any of a number of popular search engines (e.g., Google), the user will be directed to the web page (maintained by the service provider) for that community. In a class of embodiments, each of the inventive web pages is designed to promote itself (and each advertiser whose content is included therein) via the use of keywords across multiple search engines both from a paid for and organic standpoint, optimizing the search result for the customer from an exposure (front page), ease of use, and cost standpoint.

Preferably, each web page has a featured advertising area (preferably displayed at or near to the center of the page) including content provided by one realtor, and smaller advertising areas (for each realtor for which the page provides advertising space) displayed around the central featured area. The featured area “rotates” in the sense that each time a user (e.g., a potential customer) accesses the page, advertising content for a different realtor rotates into the featured area (i.e., advertising content for another realtor occupies the featured advertising area in place of the advertising content that previously occupied the featured area).

In preferred embodiments, the inventive web page includes at least one audio icon (sometimes referred to herein as a “hear more” icon) displayed with the advertising content of a realtor. A user who accesses the web page can click on the audio icon to hear prerecorded audio clips from the realtor and optionally also leave audio messages for the advertiser (e.g., in some embodiments, the web page includes instructions that prompt the user to call a specific telephone number, enter a specific identification number or other code, and then record a specific message, sometimes referred to herein as an “audio email clip,” which would then be sent to the relevant advertiser). In some embodiments, audio files are downloaded to the user's computer when the “hear more” icon is clicked. In other embodiments, audio files are not fully downloaded to user's computer (before the user can begin to play them) when the icon is clicked but are instead streamed from a service provider's computer system. The latter technique both saves space on the user's computer and enables the user to start playing a large audio file almost immediately after clicking on the “hear more” icon. Preferably, the web page is constructed such that a user who accesses it can click on the advertising content for a realtor (or on an icon included therein) to see additional displayed information provided by the realtor (e.g., information regarding specific properties offered by the realtor). Typically, this is done by asserting (downloading) another web page (including the information) to the user in response to the user's input device click. Herein, the term to “click” on an icon or other area of a web page denotes selection of the icon or area by a user using a computer input device (e.g., a mouse or other input device of customer computer system 24 of FIG. 2).

Some preferred embodiments of the inventive system provide each realtor the capability to perform one or more of the following operations: record personalized messages directly for inclusion in the realtor's advertisement (in the sense of causing a link to each such message to be displayed in the realtor's advertising space on the inventive web page) via a telephone-to-web system (preferably utilizing a direct dial feature described herein), post a podcast directly to the realtor's advertising space on the inventive web page or a web page linked thereto, post links (on the inventive web page) to real estate listing pictures on another web page (e.g., the realtor's own website), send audio Ecards to specified recipients (preferably an unlimited number of audio Ecards explaining the realtor's products or services), and send audio Emails to specified recipients (preferably an unlimited number of audio Emails). In this context, “audio Ecard” denotes a file that can be displayed (e.g., on a web page or as an email message), and when displayed includes text, one or more pictures or graphics and an “audio icon.” In response to a user click on the audio icon, audio advertising content (or other audio content) is transmitted (e.g., streamed) to the user. In this context, “audio Email” denotes a file that can be displayed as an email message, and when displayed includes text and an “audio icon.” In response to a user click on the audio icon, audio advertising content (or other audio content) is transmitted (e.g., streamed) to the user. It is contemplated that in some embodiments, advertisers would visit (e.g., download) a special audio web page to send audio Ecards or audio Emails. Such an audio web page would be different and distinct from the inventive advertising web page, and would provide an interface that allows an advertiser conveniently to generate and send audio Ecards and/or audio Emails.

Optionally, other icons displayed on (e.g., across the top of) the inventive web page indicate various other types of content. A user who accesses the web page can click on each such icon to see displayed content of the indicated type (e.g., the user's computer displays another web page including the relevant content in response to the user's click on the icon). Examples of such icons include a “home values” icon (a user who clicks on such icon is provided a menu with fields to be completed to request valuation of the user's home, e.g., if the user is considering selling the home) and a “community profile” icon (a user who clicks on such icon is provided information about the community associated with the web page).

In other embodiments, the invention is a method for marketing (i.e., for marketing at least one good and/or at least one service, which may include or consist of a good other than real estate) including the steps of:

providing a web page that includes distinct advertising space for each of N advertisers doing business in a single market (i.e., a single market for at least one good and/or service) but not for any other advertiser, where 1≦N≦8 and the advertising space for each of the N advertisers includes advertising content for said each of the N advertisers; and

sending the web page over a computer network (e.g., so that a user's computer system that downloads the web page can display the advertising content for viewing by the user). In a class of preferred embodiments, N=6. In exemplary embodiments, the market is a market for medical or financial services, or insurance (or insurance services), and each of the N advertisers provides services of the relevant type in such market. In other exemplary embodiments, the market is a market for goods of a specific type, and each of the N advertisers markets such goods in the market. Typically, the advertising space is provided for each of the N advertisers in return for consideration from said each of the advertisers. The consideration can be a monthly fee or other periodic fee and/or may be determined by a bidding process (e.g., an auction). Typically, the computer network is the internet.

In other embodiments, the invention is a method for marketing (i.e., for marketing at least one good and/or at least one service, which may include or consist of a good other than real estate) including the steps of:

providing a set of web pages, each of the web pages including distinct advertising space for each of N advertisers doing business in a different one of a set of markets (i.e., each of the web pages includes advertising space for advertisers in a single market for at least one good and/or at least one service) but not for any other advertiser, where 1≦N≦8 and the advertising space in each of the web pages for each of the N advertisers includes advertising content for said each of the N advertisers; and

sending at least one of the web pages over a computer network (e.g., so that a user's computer system that downloads the web page can display the advertising content for viewing by the user). In preferred embodiments in this class, N=6. In exemplary embodiments of this type, each of the markets is a market for medical or financial services, or insurance (or insurance services), and each of the N advertisers provides services of the relevant type in such market. In other exemplary embodiments, each of the markets is a market for goods of a specific type, and each of the N advertisers markets such goods in the market. Typically, the advertising space is provided for each of the N advertisers in return for consideration from said each of the advertisers. The consideration can be a monthly fee or other periodic fee and/or may be determined by a bidding process (e.g., an auction). Typically, the computer network is the internet.

Each feature of each real estate marketing embodiment of the invention described herein (e.g., each feature pertaining to a realtor who advertises) can be implemented in the broader class of embodiments for marketing goods and/or services (e.g., with respect to a non-realtor who advertises).

Other aspects of the invention are processors programmed to perform one or more individual steps of any embodiment of the inventive method, systems including at least one such programmed processor, and computer readable media which store code for implementing any embodiment of the inventive method. A typical embodiment of the inventive system is a host computer system (which may be a single host computer operated by a service provider, or more than one host computer, each operated by such a service provider). At least one processor of the host computer system is accessible (e.g., via a web front end) over the internet (or other network) by advertisers and potential customers.

### BRIEF DESCRIPTION OF THE DRAWINGS

FIG. 1 is a block diagram of a host computer system (17) which is an embodiment of the inventive system, and an advertiser computer system (26) and a customer computer system (24) connected thereto.

FIG. 2 is a simplified web page of the type provided to customers in a class of embodiments of the invention.

FIG. 3 is an elevational view of a computer readable medium on which is stored computer code for programming at least one processor to perform one or more individual steps of any embodiment of the inventive method.

### DETAILED DESCRIPTION OF THE INVENTION

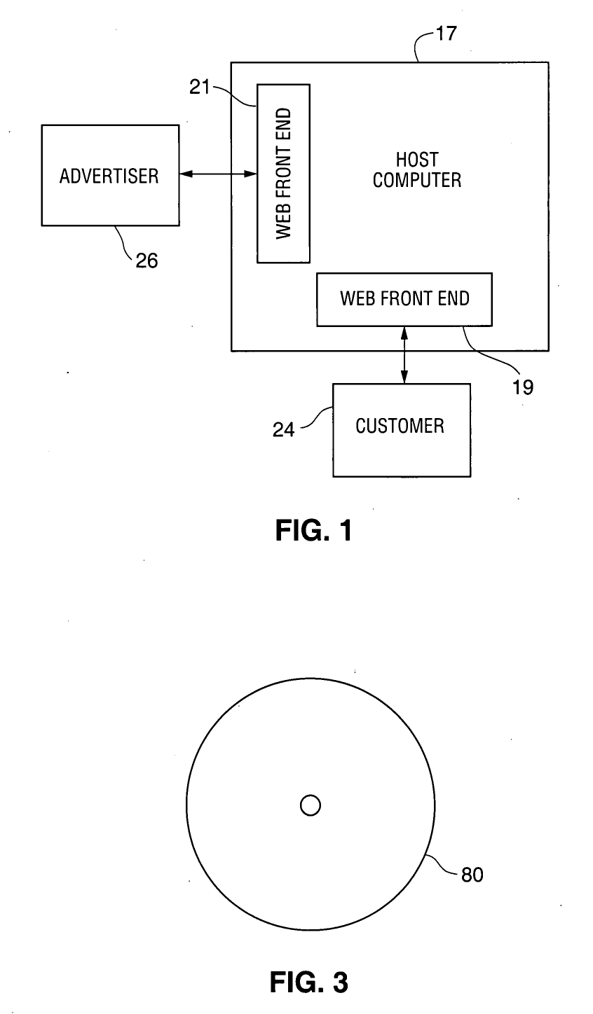

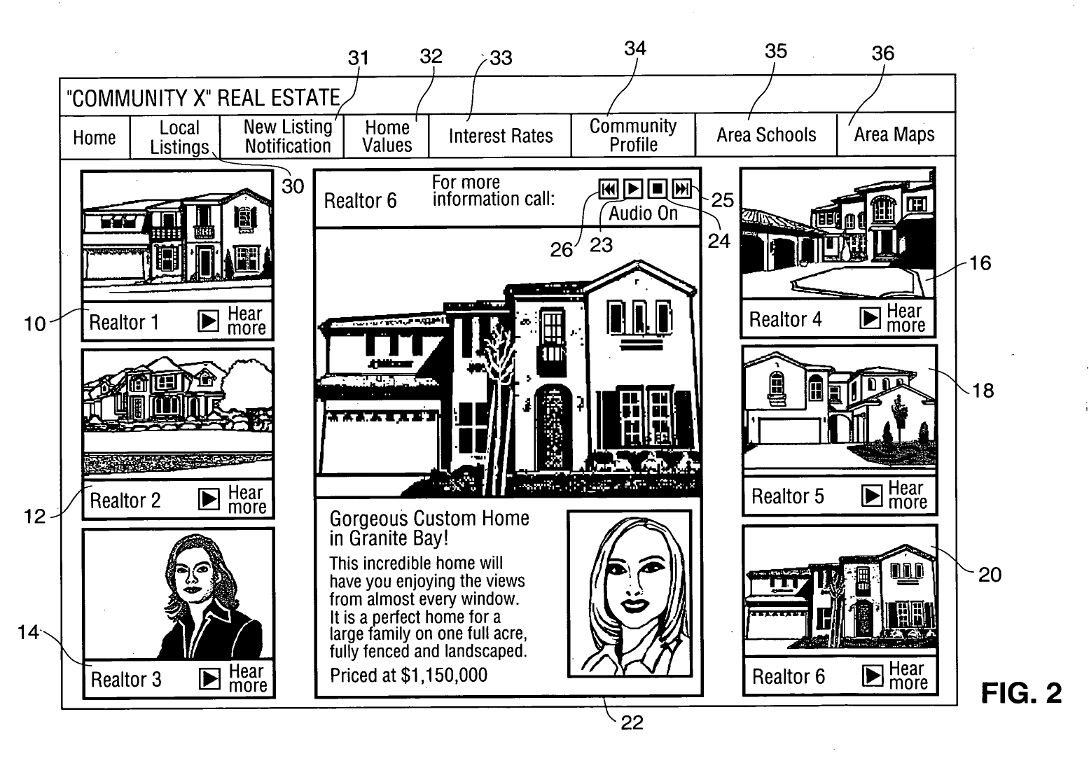

Embodiments of the inventive method and system will be described with reference to FIGS. 1 and 2.

Host computer system 17 of FIG. 1 is an embodiment of the inventive system. Each of advertiser computer system 26 and customer computer system 24 is connected to system 17 via the internet. Host computer system 17 may include a single programmed processor (a host computer) operated by a service provider. The service provider generates (and typically maintains and updates) web pages in accordance with a class of embodiments of the invention. The web pages incorporate advertising content provided by realtors (or non-realtor advertisers) who have paid consideration for advertising space. Host system 17 stores each such web page and implements an interface (e.g., interface 19) that is accessible by computers of potential customers (e.g., customer computer system 24) via the internet (or another network in alternative embodiments) so that the potential customers can access each stored web page. Preferably, interface 19 is a web front end configured to allow potential customers to access host system 17 via the internet. Alternatively, system 17 can include two or more programmed processors (e.g., a network of computers), all of which may be operated by the service provider (or another entity). Host computer system 17 can include a special-purpose server configured to handle all audio (e.g., voice) applications (e.g., streaming), as well as at least one other server configured to handle other (non-audio) required functions.

Each of computer systems 24 and 26 can be a single programmed computer or a number of networked programmed computers. At least one processor of host computer system 17 runs software for implementing an embodiment of the invention, and the same processor (or a different processor of host computer system 17) includes an interface 19 that is accessible by customer system 24 via the internet (or alternatively via another network). The same processor (or a different processor) of host computer system 17 includes an interface 21 that is accessible by advertiser computer system 26 via the internet (or alternatively via another network). Preferably, interface 21 is a web front end configured to allow advertisers to access host system 17 via the internet (e.g., to upload advertising content for inclusion in one of the inventive web pages). Although only one customer computer system 24 and one advertiser computer system 26 are shown, host computer system 17 is configured so that more than one customer computer system and more than one advertiser computer system may access host computer system 17.

FIG. 2 is a slightly simplified version web page of a type generated by an embodiment of the inventive system (e.g., host system 17 of FIG. 1) and provided to a customer (e.g., downloaded to customer computer system 24 of FIG. 1) in a class of embodiments of the invention. The web page of FIG. 2 includes advertising content directed and limited to a single real estate market (identified as “Community X” at the top of the web page). Advertising space is provided for six realtors doing business in this market (identified as “Realtor 1” through “Realtor 6” in FIG. 2), and not for other realtors doing business in the market. Typically, each of the six realtors is given the opportunity to provide advertising content for inclusion in one of six regions (advertising spaces 10, 12, 14, 16, 18, and 20 of FIG. 2) in return for consideration (e.g., a monthly fee or other periodic fee and/or may be determined by a bidding process (e.g., an auction) paid to the service provider who generates, maintains, and updates (e.g., to incorporate new advertising content from each realtor) the web page. Each realtor can be either an individual real estate agent or a realty business enterprise. Each advertising space can include text and one or more images provided by the relevant realtor, and a “hear more” icon. When a customer clicks on the advertising space (e.g., space 10, 12, 14, 16, 18, or 20) of any of the realtors, the customer is taken to a more detailed advertising web page for the realtor (in the sense that the more detailed page is downloaded to the customer's computer system) so that the customer can see more detailed displayed information provided by the realtor (e.g., information regarding specific properties offered by the realtor).

When a customer clicks on the “hear more” icon on the advertising space (e.g., space 10, 12, 14, 16, 18, or 20) of any of the realtors, audio is downloaded (e.g., streamed) to the customer's computer system so that the customer can hear prerecorded audio clips from the realtor and optionally also leave audio messages (sometimes referred to herein as “audio email clips”) for the realtor. As noted above, in some embodiments, the inventive web page includes instructions for sending audio email clips. The instructions would typically prompt a user to call a specific telephone number, enter a specific identification number or other code, and then record a specific message, which would then be sent to the relevant realtor.

Each of advertising spaces 10, 12, 14, 16, 18, and 20 is a medium-sized advertisement. The web page of FIG. 2 also has a larger “featured” advertising space 22 centered at the center of the web page, with the smaller advertising spaces 10, 12, 14, 16, 18, and 20 displayed around it. As shown in FIG. 2, featured space 22 includes content provided by the same realtor (“Realtor 6” in FIG. 2) that provided the content of space 20. However, the content of featured space 22 is “rotated” in the sense that each time a user (e.g., potential customer) accesses the page, advertising content for a different realtor is displayed in featured space 22 (i.e., advertising content for and provided by another one of Realtors 1, 2, 3, 4, 5, and 6 occupies featured space 22 in place of the advertising content that previously occupied the featured space). When a customer clicks on audio play icon 23 of the feature advertisement, audio is downloaded (e.g., streamed) to the customer's computer system so that the customer can hear prerecorded audio clips from the relevant realtor and optionally also leave audio messages (sometimes referred to herein as “audio email clips”) for the realtor. When the customer clicks on audio stop icon 24 of the featured advertisement, playback of prerecorded audio stops. When the customer clicks on audio back icon 26 (or audio forward icon 25) playback of prerecorded audio is rewound (or fast forwarded).

As explained, a primary objective of the web page of FIG. 2 is to feature advertising content of up to six realtors (e.g., only five realtors may be featured if only five have paid consideration to the service provider). The page displays a medium-sized advertisement for each featured realtor. Preferably, an enlarged version of one of the medium-sized ads (typically supplemented with additional advertising content for the relevant realtor) is displayed in a “featured” advertising area at or near to the center of the page. In typical implementations, the content of the featured advertisement (e.g., the content of featured area 22 of FIG. 2) is randomly selected automatically with each page load (or is randomly selected automatically for the initial page load and updated with each subsequent page load, with content for each other one of the realtors replacing the initially selected content in a predetermined sequence), and all medium-sized advertisements (e.g., advertising spaces 10, 12, 14, 16, 18, and 20) are rotated clockwise around the central featured area each time the page loads. Typically, the center “featured” ad is always an enlarged version (optionally including supplemental information) of the medium-sized ad displayed in the bottom right of the page.

Preferably, the inventive system provides each realtor with the capability to record personalized messages directly on its advertisement in the sense of causing a link to each such message (e.g., the link associated with icon 23 or the “hear more” icon of space 10, 12, 14, 16, 18, or 20) to be displayed in the realtor's advertising space via a telephone-to-web system. Such telephone-to-web system allows the realtor to call a predetermined telephone number (e.g., a toll free number) and, when connected, use an audio menu to record a message (and cause the message to be uploaded or “posted” to a service provider's computer system or other host system so as to be accessible either via the realtor's own website or the realtor's space on the inventive web page in response to a user click on a displayed icon) and instruct the system to perform one or more selected operations on the message. Examples of such operations on the recorded message are: linking the message to an icon on the inventive web page or another web page or website (e.g., the realtor's own website), sending the message as audio “Email” (of a type to be described below) to a predetermined list of email addresses, and including the message in an audio “Ecard” (of a type to be described below) to be sent to a predetermined list of email addresses.

Preferably, the inventive system provides each realtor with the capability to perform one or more of the following operations: post a podcast directly to the realtor's advertising space in the inventive web page or a web page linked thereto, create links (on the inventive web page) to real estate listing pictures on another web page (e.g., the realtor's own website), send audio Ecards to specified recipients (preferably an unlimited number of audio Ecards explaining the realtor's products or services), and send audio Emails to specified recipients (preferably an unlimited number of audio Emails). In this context, “audio Ecard” denotes a file that can be displayed (e.g., on a web page or as an email message), and when displayed includes text, one or more pictures or graphics, and an “audio icon.” In response to a user click on the audio icon, audio advertising content (or other audio content) is transmitted (e.g., streamed) to the user. In this context, “audio Email” denotes a file that can be displayed as an email message, and when displayed includes text and an “audio icon.” In response to a user click on the audio icon, audio advertising content (or other audio content) is transmitted (e.g., streamed) to the user.

In some embodiments, other icons displayed on the inventive web page indicate various other types of content. For example, icons 30, 31, 32, 33, 34, 35, and 36 are displayed across the top of the web page of FIG. 2, and a user who clicks on any of these icons is provided corresponding content. Specifically, the user sees displayed content of the indicated type (e.g., the user's computer displays another web page including the relevant content in response to the user's click on the icon). In response to clicking on “local listings’ icon 30, the user sees real estate listings of the featured realtors in the community associated with the web page (e.g., in response to clicking icon 30, the user sees a drop down menu with a header reading “View local listings” or the like and including links to web pages of realtors who have signed up for this feature. The user can click on these links to view real estate listings of the relevant realtors). In response to clicking on icon 31, a registration form is downloaded to the user to allow the user to request regular emailed updated listings of all properties in the specific market (e.g., not only those offered in the market by the featured realtors). In response to clicking on icon “home values” 32, the user is provided a menu with fields to be completed to request valuation of the user's home (e.g., if the user is considering selling the home). In response to clicking on “interest rates” icon 33, the user is provided information regarding current mortgage interest rates. In response to clicking on “community profile” icon 34, the user is provided information about the community associated with the web page. In response to clicking on “area schools” icon 35, the user is provided information about schools in the community associated with the web page. In response to clicking on “area maps” icon 36, the user is directed to a web page which provides a map or maps (preferably at least one interactive map) of the community associated with the web page.

In FIG. 2, icons 30, 31, 32, 33, 34, 35, and 36 are not advertising space for any advertiser. Rather, they provide links to other web pages that may or may not include advertising content.

In preferred embodiments of the invention:

in response to a user click on the realtor's name in each realtor advertising space of the inventive web page (e.g., each of spaces 10, 12, 14, 16, 18, 20, and 22 of FIG. 2) a detailed advertisement web page for the realtor is downloaded to the user's computer. Such detailed advertisement web page, sometimes referred to as a “More Information Page”, includes the realtor's contact information and email template, the property address, and optionally also other information (e.g., a longer description of the property not to exceed 900 characters in length, which is typically a different and more detailed description than what is shown in space 22 of FIG. 2, a small number of links to other web pages maintained by or for the realtor, photos, one or more links to web pages that provide virtual tours of listed properties, a web contact form, and links to prerecorded audio). Preferably, the detailed advertisement web page includes an icon (typically labeled “more photos” or the like) which leads the user to another web page including photos supplied by the realtor;

each picture displayed in each realtor advertising space of the inventive web page has a short corresponding text (which may include the realtor's name and the realtor's company if the realtor is an individual). A longer text (typically limited to include a two-line title and to have a maximum number of lines of text, e.g., five lines of text) is also associated with the picture displayed in each realtor advertising space. This longer text is visible only when an enlarged version of the picture is displayed in the featured center area (e.g., area 22 of FIG. 2) of the web page (typically with the realtor's name, contact information, and an audio play button above the center picture). Typically, the longer text can include a MLS number and an associated price;

the advertising content displayed in the featured center area (e.g., area 22 of FIG. 2) of the web page can include a photograph of the realtor if one is provided by the realtor (if not, the spot for the photograph is blank); and/or

the advertising content displayed in the featured center area (e.g., area 22 of FIG. 2) of the web page can include a real estate agent name, company name, and phone number(s) if these are provided by the realtor.

In a class of embodiments, each of the inventive web pages is designed to promote itself (and each advertiser whose content is included therein) via the use of keywords across multiple search engines both from a paid for and organic standpoint, optimizing the search result for the customer from an exposure (front page), ease of use, and cost standpoint. It is contemplated that in typical embodiments, a potential customer (user) of the inventive web page will find the web page as a result of a search using an internet search engine (e.g., Google, Yahoo, MSN, or Ask). The user would input a keyword search term (e.g., San Mateo Calif. Real Estate) into one of the many search engines available. The user can only view and enter keyword search terms on one search engine at a time. As an example, when a user enters a search term on Google the user is brought to page one of multiple Google search result pages with matching search terms. There are two distinctive sections to this page: a section including “paid for” (sponsored) links; and a section including organic links (links which are naturally or organically selected based on the search algorithm).

Conventionally, it is typical for an advertiser to choose a search engine company it would like to advertise with on a “paid for” (sponsored) basis, open an account with the search engine company (specifying key words that will trigger appearance of a link, on a search result page, to a web page of the advertiser), and determine how much to spend (e.g., on a cost per click basis and a total dollar amount per day or month basis) for advertising. For example, an advertiser with a $250 monthly budget and a maximum cost per click of $1.25 would be able to obtain 200 clicks per month (assuming that each click costs the maximum amount) or an average of 6.67 clicks per day of a 30-day month. The particular search result page (of a set of pages resulting from a search) on which the link to the advertiser's web page appears, and the advertiser link's position on that search result page, typically depend on the amounts other advertisers have agreed to pay the search engine company. If $1.25 per click is at the high end of the range of payments per click that advertisers have agreed to pay, the advertiser in the example would likely receive front page exposure (exposure in the sponsored link section of the first search result page of a set of search result pages resulting from a search that included one of the specified key words) since in this case the advertiser would be one of the highest bidders.

In a class of embodiments, each of the inventive web pages is promoted using paid for keywords on multiple search engines. For example, the advertiser's exposure in the above example (6.67 clicks per day for a month) can be increased in accordance with these embodiments across multiple search engines using the monetary synergies of the six (or other small number of) advertisers whose content appears on each of the inventive web pages. For example, a service provider who maintains and promotes the inventive web pages may allocate 34% of total revenue received from advertisers to paid for advertising ($250 per advertiser per month×6 advertisers×34%=$510 per month). With this advertising budget ($510 dollars per month) the service provider could achieve 408 hits per month (=$510 per month/$1.25 per hit) which is an average of 13.6 hits per day. This is a 105% increase over the results that one of the six advertisers could achieve on its own using the conventional “paid for” search engine approach. Preferably, a service provider who maintains and promotes the inventive web pages would have accounts with all major search engines and would list a set of “paid for” key words (search terms), which apply to all advertisers whose content appears on a single one of the inventive web pages, on multiple search engines; not just one search engine as an advertiser would typically do using the conventional “paid for” search engine approach. Even if an advertiser would purchase conventional “paid for” search engine promotion on multiple search engines, the cost of doing so would likely be greater on a per click basis than if the advertiser would advertise using an embodiment of the inventive web page, and each potential customer who clicks on the advertiser's website (as a result of the conventional “paid for” search engine promotion) would receive only the general message conveyed by the website (which is typically a general website promoting different services and products, often in different markets); not the specific advertising message delivered by the inventive web page.

Also preferably, a service provider who maintains and promotes the inventive web pages would aggressively improve organic page ranking (on multiple search engines) for the inventive web page through use of expert (e.g., professional) search engine optimization engineering while at the same time using “paid for” search engine promotion with multiple search engines as described above.

To understand preferred techniques for promotion of a class of embodiments of the inventive web pages, it is important to consider how different search engines typically select and rank links to web pages on a natural or organic basis. Typically, each search engine company uses a different method or algorithm to determine the order in which web pages are selected organically. Exactly how a search engine's algorithm works is typically a closely-kept trade secret. In preferred embodiments, the service provider who maintains and promotes the inventive web pages would identify its competitors. One definition of such a competitor is an entity having a web page (other than the inventive web page) promoting a similar service or product in the same local market. By using expert (e.g., professional) search engine optimization engineering that considers the different variables associated with all the relevant search engine algorithms and applies this knowledge on a page by page and site by site basis, and continually updating, linking, and providing changes to the inventive web pages, the inventive web pages can be kept at or near the top of the major search engine listings from an organic standpoint. The infrastructure of the inventive web page is preferably designed to be easily recognized by all relevant search engines. The process of promoting the inventive web pages is a dynamic function, and the relevant rules and factors typically change frequently.

In a class of embodiments, the invention is a method for marketing (i.e., marketing real estate and/or at least one other good and/or at least one service), including the steps of:

providing a web page that includes distinct advertising space for each of N advertisers doing business in a single market (i.e., a single market for at least one good and/or service) but not for any other advertiser, where 1≦N≦8, said web page including advertising content for each of the N advertisers; and

sending the web page over a computer network (e.g., so that a user's computer system that downloads the web page can display the advertising content for viewing by the user). In preferred embodiments in this class, N=6. In exemplary embodiments, the market is a market for medical or financial services, or insurance (or insurance services), and each advertiser provides services of the relevant type (or insurance) in such market. In other exemplary embodiments, the market is a market for goods of a specific type (e.g., real estate), and each advertiser markets such goods in the market. Typically, the advertising space is provided for each of the advertisers in return for consideration from said each of the advertisers. The consideration can be a monthly fee or other periodic fee. Typically, the computer network is the internet.

Each feature of each real estate marketing embodiment of the invention described herein (e.g., each feature pertaining to a realtor who advertises) can be implemented in the broader class of embodiments for marketing goods other than real estate and/or services (e.g., with respect to a non-realtor who advertises). For example, to market insurance rather than real estate (or related services), the web page of FIG. 2 would be modified appropriately, including by replacing each of advertising areas 10, 12, 14, 16, 18, and 20 with an advertising area identifying an entity providing insurance or insurance-related services (e.g., an insurance firm or other insurer, or an insurance agent or broker), and replacing featured advertising area 22 with a featured advertising area including advertising content provided by one such entity providing insurance or insurance-related services. Such a modified version of the web page of FIG. 2 would preferably implement audio content features (and display “hear more” and other audio icons) of the type described above with reference to FIG. 2.

In another class of embodiments, the invention is a method for marketing real estate including the steps of:

providing a set of web pages, each of the web pages including distinct advertising space for each of N realtors doing business in a different one of a set of real estate markets (“communities”) but not for any other realtor, where 1≦N≦8, and where each of the web pages includes advertising content for each of the N realtors for which said each of the web pages includes advertising space; and

sending at least one of the web pages over a computer network (e.g., so that a user's computer system that downloads the web page can display the advertising content for viewing by the user). In preferred embodiments in this class, N=6. For example, one web page in the set has the appearance of the web page of FIG. 2 and includes distinct advertising space for each of N (e.g., N=6) realtors marketing real estate in a first community (“community X” as in FIG. 2) and includes advertising content for each of these N realtors, and another web page in the set has the appearance of the web page of FIG. 2 but includes distinct advertising space for each of another set of N realtors marketing real estate in a second community (and advertising content for each of these N realtors). In typical embodiments in this class, the advertising space is provided for each of the realtors in return for consideration from said each of the realtors. Each realtor can be either an individual real estate agent or a realty business enterprise. Typically, the computer network is the internet.

In a broader class of embodiments, the invention is a method for marketing (i.e., marketing at least one good and/or at least one service), including the steps of:

providing a set of web pages, each of the web pages including distinct advertising space for each of N advertisers doing business in a single market (i.e. a single market for at least one good and/or at least one service) but not for any other advertiser who markets in said market, where 1≦N≦8, and where each of the web pages includes advertising content for each of the N advertisers for which said each of the web pages includes advertising space; and

sending at least one of the web pages over a computer network (e.g., so that a user's computer system that downloads one said web page can display the advertising content included therein for viewing by the user). In preferred embodiments in this class, N=6. For example, one web page in the set has appearance similar to that the web page of FIG. 2 but includes distinct advertising space for each of N (e.g., N=6) advertisers marketing a specific type of service (e.g., insurance) in a first community (“community X” as in FIG. 2) and includes advertising content for each of these N advertisers, and another web page in the set has appearance similar to that the web page of FIG. 2 but includes distinct advertising space for each of another set of N advertisers who market the same type of service in a second community (and advertising content for each of these N realtors). Each advertiser can be a realtor (e.g., an individual real estate agent or a realty business enterprise marketing real estate in the relevant market) or an advertiser marketing at least one good other than real estate and/or at least one service in the relevant market. In exemplary embodiments, the market is a market for medical, insurance, or financial services, and each advertiser provides services of the relevant type in such market. Typically, the computer network is the internet. The consideration can be a monthly fee or other periodic fee.

FIG. 3 is an elevational view of a computer readable medium (80), which may be an optical disk or set of optical disks, on which is stored computer code for programming at least one processor (e.g., a processor of host computer system 17) to perform one or more individual steps of any embodiment of the inventive method.

While this invention has been described in terms certain preferred embodiments, it will be appreciated by those skilled in the art that certain modifications, permutations and equivalents thereof are within the inventive scope of the present invention. It is therefore intended that the following appended claims include all such modifications, permutations and equivalents as fall within the true spirit and scope of the present invention.

What is claimed is:

1. A method of computer-implemented marketing, including the steps of:
(a) providing a web page that includes distinct advertising space for each of N advertisers doing business in a single market but not for any other advertiser, where 1≦N≦8 and the advertising space for each of the N advertisers includes advertising content for said each of the N advertisers; and
(b) sending the web page over a computer network.

2. The method of claim 1, wherein N=6.

3. The method of claim 1, wherein the advertisers are realtors, and each of the realtors markets real estate in the market.

4. The method of claim 3, wherein a service provider performs step (a) in return for consideration from each of the realtors.

5. The method of claim 3, wherein N=6, and the computer network is the internet.

6. The method of claim 3, wherein the web page has a featured advertising area including advertising content provided by one of the realtors, and non-featured advertising areas, and each of the non-featured advertising areas is smaller than the featured advertising area and includes advertising content for a different one of the realtors.

7. The method of claim 3, also including the steps of:
in response to a first request for access to the web page, sending over the computer network a version of the web page having a featured advertising area including advertising content provided by one of the realtors and non-featured advertising areas, where each of the non-featured advertising areas is smaller than the featured advertising area and includes advertising content for a different one of the realtors; and
in response to a subsequent request for access to the web page, sending over the computer network a second version of the web page having a featured advertising area that includes advertising content provided by a second one of the realtors, wherein the second version of the web page also includes the non-featured advertising areas.

8. The method of claim 3, wherein at least one audio icon is included in the web page with the advertising content of one of the realtors.

9. The method of claim 1, wherein each of the advertisers offers medical services in said market.

10. The method of claim 1, wherein each of the advertisers offers insurance in said market.

11. The method of claim 1, wherein each of the advertisers offers financial services in said market.

12. The method of claim 1, wherein the computer network is the internet.

13. The method of claim 1, wherein the web page has a featured advertising area including advertising content provided by one of the advertisers, and non-featured advertising areas, where each of the non-featured advertising areas is smaller than the featured advertising area and includes advertising content for a different one of the advertisers.

14. The method of claim 1, including the steps of:
in response to a first request for access to the web page, sending over the computer network a version of the web page having a featured advertising area including advertising content provided by one of the advertisers and non-featured advertising areas, where each of the non-featured advertising areas is smaller than the featured advertising area and includes advertising content for a different one of the advertisers; and
in response to a subsequent request for access to the web page, sending over the computer network a second version of the web page having a featured advertising area including advertising content provided by a second one of the advertisers, wherein the second version of the web page also includes the non-featured advertising areas.

15. The method of claim 1, wherein at least one audio icon is included in the web page with the advertising content of one of the advertisers.

16. The method of claim 1, also including the step of:
in response to a user click on the advertising space for one of the advertisers, sending over the computer network another web page that includes additional information provided by said one of the advertisers.

17. The method of claim 1, also including the step of:
recording, and uploading to a host system, a telephoned message from one of the advertisers; and
in response to a user click on an icon in the advertising space for said one of the advertisers, sending the recorded message from the host system to a computer system of the user.

18. The method of claim 1, wherein the advertising space for one of the advertisers includes an audio icon, and wherein the method also includes the step of:
in response to a user click on the audio icon, sending prerecorded audio content to a computer system of the user.

19. A method of computer-implemented marketing, including the steps of:
providing a set of web pages, each of the web pages including distinct advertising space for each of N advertisers doing business in a different one of a set of markets but not for any other advertiser, where 1≦N≦8 and the advertising space in each of the web pages for each of the N advertisers includes advertising content for said each of the N advertisers; and
sending at least one of the web pages over a computer network.

20. The method of claim 19, wherein N=6.

21. The method of claim 19, wherein the computer network is the internet.

22. The method of claim 19, wherein each of the markets is a market for medical services, and each of the N advertisers in each of the markets offers medical services in said each of the markets.

23. The method of claim 19, wherein each of the markets is a market for financial services, and each of the N advertisers in each of the markets offers financial services in said each of the markets.

24. The method of claim 19, wherein each of the markets is a market for insurance and each of the N advertisers in each of the markets offers insurance in said each of the markets.

25. The method of claim 19, wherein each of the markets is a real estate market, and each of the N advertisers in each of the markets is a realtor that markets real estate in said each of the markets.

26. The method of claim 25, wherein N=6 and the computer network is the internet.

27. The method of claim 19, wherein each of the web pages has a featured advertising area including advertising content provided by one of the advertisers, and non-featured advertising areas, where each of the non-featured advertising areas is smaller than the featured advertising area and includes advertising content for a different one of the advertisers.

28. The method of claim 19, wherein at least one audio icon is included in each of the web pages with the advertising content of one of the advertisers.

29. The method of claim 19, also including the step of:
recording, and uploading to a host system, a telephoned message from one of the advertisers; and
in response to a user click on an icon in the advertising space for said one of the advertisers, sending the recorded message from the host system to a computer system of the user.

30. The method of claim 19, wherein the advertising space for one of the advertisers includes an audio icon, and wherein the method also includes the step of:
in response to a user click on the audio icon, sending prerecorded audio content to a computer system of the user.

31. A system for computer-implemented marketing, including at least one processor programmed to:
(a) store a web page that includes distinct advertising space for each of N advertisers doing business in a single market but not for any other advertiser, where 1≦N≦8 and the advertising space for each of the N advertisers includes advertising content for said each of the N advertisers; and
(b) send the web page over a computer network in response to a request for access to the web page.

32. The system of claim 31, wherein N=6.

33. The system of claim 31, wherein the advertisers are realtors, and each of the realtors markets real estate in the market.

34. The system of claim 33, wherein N=6, and the computer network is the internet.

35. The system of claim 33, wherein the web page has a featured advertising area including advertising content provided by one of the realtors, and non-featured advertising areas, and each of the non-featured advertising areas is smaller than the featured advertising area and includes advertising content for a different one of the realtors.

36. The system of claim 33, wherein at least one audio icon is included in the web page with the advertising content of one of the realtors.

37. The system of claim 31, wherein N=6, and the computer network is the internet.

38. The system of claim 31, wherein the web page has a featured advertising area including advertising content provided by one of the advertisers, and non-featured advertising areas, where each of the non-featured advertising areas is smaller than the featured advertising area and includes advertising content for a different one of the advertisers.

39. The system of claim 31, wherein the at least one processor is also programmed to:
in response to a first request for access to the web page, send over the computer network a version of the web page having a featured advertising area including advertising content provided by one of the advertisers and non-featured advertising areas, where each of the non-featured advertising areas is smaller than the featured advertising area and includes advertising content for a different one of the advertisers; and
in response to a subsequent request for access to the web page, send over the computer network a second version of the web page having a featured advertising area including advertising content provided by a second one of the advertisers, wherein the second version of the web page also includes the non-featured advertising areas.

40. The system of claim 31, wherein at least one audio icon is included in the web page with the advertising content of one of the advertisers.

41. The system of claim 31, wherein the at least one processor is also programmed to:
in response to a user click on the advertising space for one of the advertisers, send over the computer network another web page that includes additional information provided by said one of the advertisers.

42. The system of claim 31, wherein the at least one processor is also programmed to:
store as audio data a telephoned message from one of the advertisers; and
in response to a user click on an icon in the advertising space for said one of the advertisers, send the audio data over the computer network to a computer system of the user.

43. The system of claim 31, wherein the advertising space for one of the advertisers includes an audio icon, and wherein the at least one processor is also programmed to:
in response to a user click on the audio icon, send prerecorded audio content over the computer network to a computer system of the user.
